(19) United States
(12) Patent Application Publication
(10) Pub. No.: US 2020/0191290 A1
(43) Pub. Date: Jun. 18, 2020

(54) Sanitary mixer valve

(71) Applicant: Jurgen Verwoert, Rotterdam (NL)

(72) Inventor: Jurgen Verwoert, Rotterdam (NL)

(21) Appl. No.: 16/336,525

(22) PCT Filed: Sep. 14, 2017
(86) PCT No.: PCT/IB2017/055563

§ 371 Date: Mar. 26, 2019

(30) Foreign Application Priority Data
Oct. 3, 2016 (NL) 1042088

(51) Int. Cl. F16K 11/00; G05D 23/13; F16K 11/22

(52) U.S. Cl. CPC F16K 19/006; E03C 1/0403; F16K 11/22; G05D 23/1393

(57) ABSTRACT

The invention includes a sanitary shower system with a mixing valve which can mix the hot and cold water supplies through the linearly movable triangle element to the desired exit temperature and flow volume. The triangular element has a slanted side that seamlessly connects to the inclined side of hot and cold water inlet ducts of the valve housing, in which there is also the flexible seal to achieve complete sealing. The triangle element is provided with a protrusion on the oblique side. This determines the flow rate of the hot and cold water supply towards the mixing chamber very accurately.

The invention includes a sanitary shower system with a mixing valve which can mix the hot and cold water supplies through the linearly movable triangle element to the desired exit temperature and flow rate. The triangular element has a slanted side that seamlessly connects to the inclined side of hot and cold water inlet ducts of the valve housing, in which there is also the flexible seal to achieve complete sealing. The triangle element is provided with a protrusion on the oblique side. This determines the flow rate of the hot and cold water supply towards the mixing chamber very accurately.

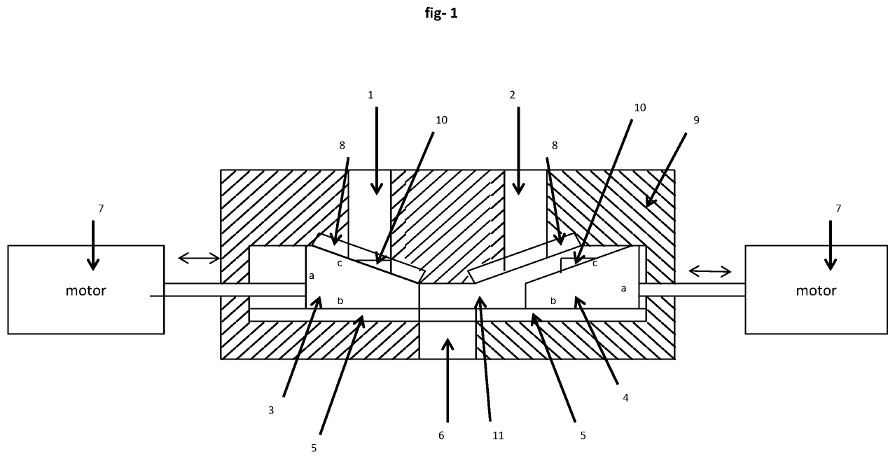

With reference to the drawing (FIG. 1) the operation will be described.

FIG. 1 describes that the hot (FIG. 1/1) and cold water (FIG. 1/2) are supplied by means of Triangular element (FIG. 1/3, 4), the flow rate can be adjusted continuously and without the intervention of other components and/or moving parts, the desired temperature and flow volume can be directed towards the mixing chamber (FIG. 1/11) and then exit the valve via the valve outlet (FIG. 1/6).

That triangle element (FIG. 1/3,4) with the vertical side (A) is individually controlled by means of Two linear stepping motors (FIG. 1/7) resulting in a linear movement of the triangle element (FIG. 1/3,4) in the mixing chamber (FIG. 1/11) of the valve body (FIG. 1/9).

That the triangle element (FIG. 1/3,4) with the lying side (FIG. 1/B) is guided along the guide (FIG. 1/5) located in the crane housing (FIG. 1/9).

That the sloping side (C) of the triangle element (FIG. 1/3,4) can open or close the hot (FIG. 1/1) and cold water inlets (FIG. 1/2) individually by means of a linear movement, thus allowing the flow of the Hot (FIG. 1/1) or cold water inlets (FIG. 1/2) is influenced so that the desired output temperature and flow through volume are reached via the mixing chamber (FIG. 1/11) and outlet (FIG. 1/6).

That the oblique side (C) of the triangle element (FIG. 1/3,4) has a protrusion (FIG. 1 10) completely falling into the opening of the hot and cold water inlets (FIG. 1/1,2) when the triangle element (FIG. 1/3,4) makes a linear motion the hot and cold water inlets (FIG. 1/1,2) are completely sealed.

When opening and closing the triangle element (FIG. 1/3,4), the protrusion (FIG. 1/10) provides a gradual flow of the hot and cold water supply (FIG. 1/1.2), resulting in a stable and constant outlet temperature and flow in mixing chamber FIG. 1/11) and output (FIG. 1/6).

That the crane housing (FIG. 1/9) has a oblique side (FIG. 1/8) on which the triangle element (FIG. 1/3,4) connects, and can cut off the flow of the hot (FIG. 1/1) and/or cold (FIG. 1/2) water supply to the mixing chamber (FIG. 1/11) and crane outlet (FIG. 1/6).

That the crane housing (FIG. 1/9) has a oblique side (FIG. 1/8) from which the hot and cold water supplies (FIG. 1/1 and 2) get into the mixing chamber (FIG. 1/11)

1. A sanitary mixer valve wherein the triangular element (FIG. 1/3,4) is provided with three sides (A,B,C). The standing side (A) is connected to the linear motor (FIG. 1/7) linearly advancing the triangular element (FIG. 1/3,4) with the lying side (B) along the valve guide (FIG. 1/5) of the valve housing (FIG. 1/9). With the linear advancement of the triangle element (FIG. 1/3,4), the hot and cold water supplies (FIG. 1/1,2) are fully opened and/or closed. The closing is due to the oblique side (C) of the triangular element (FIG. 1/3,4) against the equivalent oblique side (FIG. 1/8) of the valve housing (FIG. 1/9) by the linear advancement of the linear motor (FIG. 1/7) which ensures a seamless sealing. The hot and cold water supplies (FIG. 1/1,2) pour in the oblique sides (FIG. 1/8) of the valve and are equivalent to the oblique sides (C) of the triangular element (FIG. 1/3,4).

2. A sanitary mixer valve to claim 1, wherein the triangular element (FIG. 1/3,4) only supplies the oblique side (C) for direct sealing of the hot and cold water (FIG. 1/1.2) direction of mixing chamber (FIG. 1/11) and crane outlet (FIG. 1/6).

3. A sanitary mixer valve to claims 1 and 2, wherein the water and water flow streams of the hot and cold water supply (FIG. 1/1) and (FIG. 1/2) flow into the mixing chamber (FIG. 1/11) via the oblique side (FIG. 1/8) Of the valve housing (FIG. 1/9).

4. A sanitary mixer valve to claims 1, 2 and 3 wherein the triangle element (FIG. 1/3,4) with the lying side (B) is passed along the guide housing (FIG. 1/5) of the valve housing (FIG. 1/9) Led.

5. A sanitary mixer valve to claims 1, 2, 3 and 4, wherein the triangle element (FIG. 1/3,4) is linearly moved by a linear stepping motor (FIG. 1/7) which is connected to the standing side (A) of the triangle element (FIG. 1/3,4).

6. A sanitary mixer valve to claims 1, 2, 3, 4 and 5 wherein triangle element (FIG. 1/3,4) is designed that when there is an angle of 30 degrees between the lying (B) and the oblique (C) side is that there is a doubling of the linear force from motor (FIG. 1/7) towards the upward force of the oblique side (C) takes place.

7. A sanitary mixer valve to claims 1, 2, 3, 4, 5 and 6, wherein the oblique side (C) of the triangle element (FIG. 1/3,4) is provided with a protrusion (FIG. 1/10). When the triangle element (FIG. 1/3,4), is closed, the protrusion (FIG. 1/10) is completely positioned in the passage of the hot (FIG. 1/1) and cold (FIG. 1/2) water supplies.

8. A sanitary mixer valve to claims 1, 2, 3, 4, 5, 6 and 7, during which the protrusion (FIG. 1/10) closes a gradual flow of the hot (FIG. 1/1) and cold (FIG. 1/2) water, resulting in a linear control characteristic between a maximum hot and maximum cold water flow towards the mixing chamber (FIG. 1/11) and outlet (FIG. 1/6).
